(19) United States
(12) Patent Application Publication
(10) Pub. No.: US 2019/0160843 A1
(43) Pub. Date: May 30, 2019

(54) GRAVURE PRINTING APPARATUS, GRAVURE PRINTING METHOD, AND PRINTED MATTER MANUFACTURING METHOD

(71) Applicant: THINK LABORATORY CO., LTD, Chiba (JP)

(72) Inventor: Tatsuo SHIGETA, Chiba (JP)

(73) Assignee: THINK LABORATORY CO., LTD, Chiba (JP)

(21) Appl. No.: 16/312,049

(22) PCT Filed: Jun. 21, 2017
(86) PCT No.: PCT/JP2017/022809

§ 371 Date: Dec. 20, 2018

(30) Foreign Application Priority Data
Jun. 27, 2016 (JP) 2016-126687
Jul. 8, 2016 (JP) 2016-135996

(51) Int. Cl. B41M 1/10; B41F 9/10; B41F 23/00; B41F 13/187

(52) U.S. Cl. CPC B41M 1/10; B41F 13/187; B41F 23/00; B41F 9/10

(57) ABSTRACT

Provided is a gravure printing apparatus, a gravure printing method, and a printed matter manufacturing method in which the ink transfer characteristics in gravure printing are controlled to be improved. The gravure printing apparatus includes: a gravure plate cylinder; a doctor blade configured to scrape off a superfluous ink from a plate surface of the gravure plate cylinder; an impression cylinder configured to press a base material to be printed against the plate surface to transfer the ink remaining in a cell of the gravure plate cylinder; and a transfer characteristics control mechanism configured to control ink transfer characteristics by supplying a gas selected from the group consisting of air having predetermined humidity, dry air, and an inert gas to at least a part of an ink transfer characteristics control area between an ink scraping-off point of the doctor blade on the plate surface and a pressing point of the impression cylinder on the plate surface.

### TECHNICAL FIELD

The present invention relates to a gravure printing apparatus, a gravure printing method, and a printed matter manufacturing method in which ink transfer characteristics in gravure printing are improved.

### BACKGROUND ART

In gravure printing, minute recesses (gravure cells) are formed in a gravure plate-making roll (gravure cylinder) in accordance with plate making information to make a plate surface, and an ink is filled in the gravure cells and transferred to a material to be printed. In a general gravure plate-making roll, plate making (making of a plate surface) is completed through the processes involving providing a copper-plating layer (plate material) for forming a plate surface to a surface of a hollow roll made of a metal such as aluminum or iron or a reinforced resin such as a carbon fiber reinforced resin (CFRP), forming a large number of minute recesses (gravure cells) in the copper-plating layer in accordance with plate making information by etching, and then forming, on the surface of the copper-plating layer, a surface hardening coating layer such as chromium plating for enhancing a withstand print force of the gravure plate-making roll.

In gravure printing, there is a problem in ink transfer characteristics. Plate fogging in gravure printing is a phenomenon in which an ink minutely adheres to a non-engraved region (portion of a plate surface for printing to which a printing ink does not adhere), resulting in dirty-looking printing. Plate fogging occurs, for example, when the continuous use time of a doctor blade is prolonged to cause the doctor blade to become blunt, when the process of evenly forming streaks in the non-engraved region of chromium plating of a gravure roll with sandpaper is not sufficiently performed, or when the printing speed of a rotary press is excessively high.

Plate fogging is caused by transfer of minute ink droplets having passed through the doctor blade to the non-engraved region of the plate surface for printing without being dried. The case in which the amount of an ink causing plate fogging in the non-engraved region of the plate surface for printing is large is caused by the following. The doctor blade becomes blunt to cause an insufficient scraping-off function with respect to an ink. Alternatively, the above-mentioned case is caused by the following. The plate surface for printing has an unsatisfactory self-lubricating property due to an excessive mirror-surface state thereof, and hence the doctor blade and the roll surface are brought into direct contact with each other to cause minute vibration of the doctor blade, resulting in passage of an ink.

Further, in gravure printing, in order to effectively prevent a partial transfer failure caused by plate drying that occurs in a pattern end portion, that is, blurring, there has also been proposed a gravure plate in which minute cells are formed on an entire surface of the non-engraved region of the plate surface of the gravure plate (Patent Document 1).

### PRIOR ART DOCUMENTS

### Patent Documents

### Patent Document 1: JP 2005-153201A

### DISCLOSURE OF THE INVENTION

### Problems to be Solved by the Invention

The present invention has an object to provide a gravure printing apparatus, a gravure printing method, and a printed matter manufacturing method in which the ink transfer characteristics in gravure printing are controlled to be improved.

### Means for Solving Problems

In order to solve the above-mentioned problem, a gravure printing apparatus according to the present invention, including: a gravure plate cylinder; a doctor blade configured to scrape off a superfluous ink from a plate surface of the gravure plate cylinder; an impression cylinder configured to press a base material to be printed against the plate surface to transfer an ink remaining in a cell of the gravure plate cylinder; and a transfer characteristics control mechanism configured to control ink transfer characteristics by supplying a gas selected from the group consisting of air having predetermined humidity, dry air, and an inert gas to at least a part of an ink transfer characteristics control area between an ink scraping-off point of the doctor blade on the plate surface and a pressing point of the impression cylinder on the plate surface.

It is preferred that the transfer characteristics control mechanism include a casing arranged above the ink transfer characteristics control area so as to cover the ink transfer characteristics control area, a lower surface of the casing be positioned so as to face a circumferential surface of the gravure plate cylinder, the lower surface of the casing be formed in an arc shape having a curvature along the circumferential surface of the gravure plate cylinder, and that a gas blow-out port be formed on the lower surface.

Preferably, a predetermined humidity of the air having predetermined humidity is 10% RH to 80% RH. Further, as the dry air, air having RH of less than 10% can preferably be used.

Preferably, the transfer characteristics control mechanism includes a gas supply amount regulating mechanism configured to regulate a supply amount of the gas.

It is preferred that the gas supply amount regulating mechanism include: at least one of a thermometer configured to measure a temperature of an ink transfer characteristics control area atmosphere that is an atmosphere of the ink transfer characteristics control area between the lower surface of the casing and the circumferential surface of the gravure plate cylinder; a hygrometer configured to measure a humidity of the ink transfer characteristics control area atmosphere; and a temperature sensor configured to measure a plate surface temperature of the gravure plate cylinder, and that the supply amount of the gas be regulated by performing feedback control. It is preferred that the ink transfer characteristics control area between the lower surface of the casing and the circumferential surface of the gravure plate cylinder be as close as possible to a closed system. Further, it is preferred that the temperature and humidity of the ink transfer characteristics control area atmosphere be regulated to predetermined temperature and humidity.

A gravure printing method according to the present invention is a gravure printing method including: through use of the gravure printing apparatus, after scraping off a superfluous ink from a plate surface of the gravure plate cylinder with the doctor blade; supplying a gas selected from the group consisting of air having predetermined humidity, dry air, and an inert gas to at least a part of an ink transfer characteristics control area between an ink scraping-off point of the doctor blade on the plate surface and a pressing point of the impression cylinder on the plate surface; and pressing the base material to be printed against the plate surface with the impression cylinder to transfer an ink remaining in a cell of the gravure plate cylinder onto the base material to be printed.

A printed matter manufacturing method according to the present invention is a printed matter manufacturing method, including: through use of the gravure printing apparatus, after scraping off a superfluous ink from a plate surface of the gravure plate cylinder with the doctor blade; supplying a gas selected from the group consisting of air having predetermined humidity, dry air, and an inert gas to at least a part of an ink transfer characteristics control area between an ink scraping-off point of the doctor blade on the plate surface and a pressing point of the impression cylinder on the plate surface; and pressing the base material to be printed against the plate surface with the impression cylinder to transfer an ink remaining in a cell of the gravure plate cylinder onto the base material to be printed, to thereby manufacture a printed matter.

### Advantageous Effects of the Invention

The present invention exhibits a remarkable effect capable of providing a gravure printing apparatus, a gravure printing method, and a printed matter manufacturing method in which the ink transfer characteristics in gravure printing are controlled to be improved.

### BRIEF DESCRIPTION OF DRAWINGS

FIG. 1 is a schematic side view for illustrating one embodiment of a gravure printing apparatus according to the present invention.

FIG. 2 is a schematic perspective view for illustrating the one embodiment of the gravure printing apparatus according to the present invention.

FIG. 3 is a schematic perspective view of a transfer characteristics control mechanism of the gravure printing apparatus of FIG. 2 when viewed from a lower side.

FIG. 4 is a block diagram for illustrating one embodiment of the transfer characteristics control mechanism.

### DESCRIPTION OF EMBODIMENTS

Embodiments of the present invention are described below, but those embodiments are described as examples, and hence it is understood that various modifications may be made thereto without departing from the technical spirit of the present invention. In addition, the same members are represented by the same reference symbols.

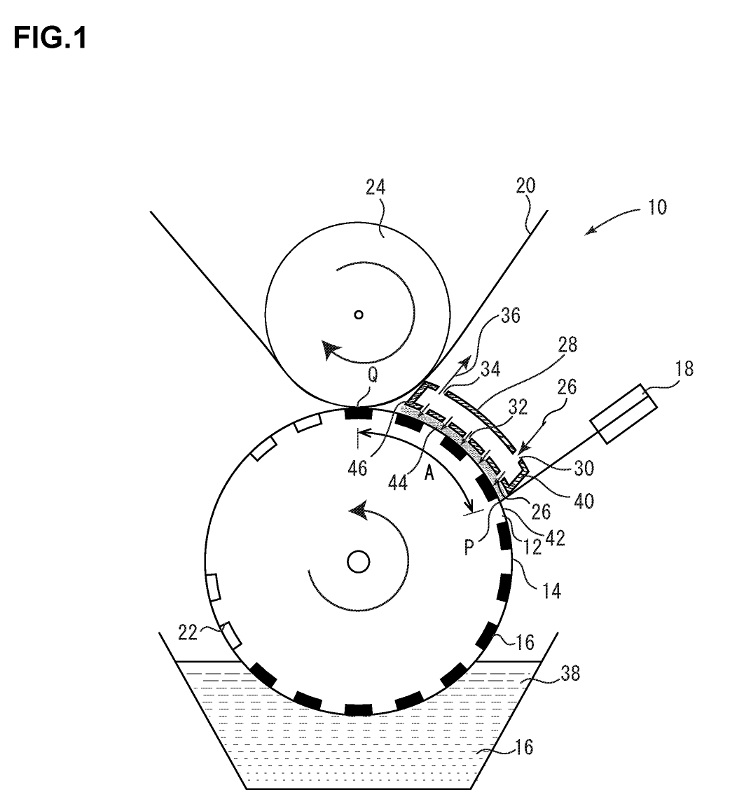

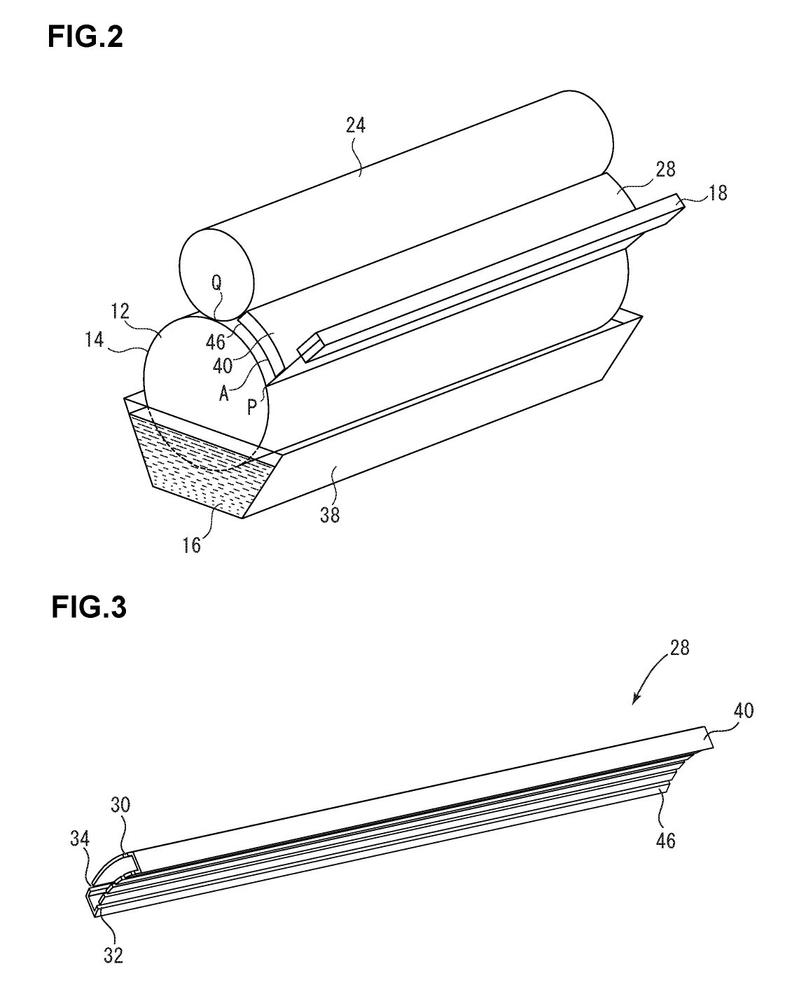

In FIG. 1 to FIG. 2, there is illustrated a gravure printing apparatus 10 according to the present invention. The gravure printing apparatus 10 includes a gravure plate cylinder 12, a doctor blade 18 configured to scrape off a superfluous ink 16 from a plate surface 14 of the gravure plate cylinder 12, an impression cylinder 24 configured to press a base material 20 to be printed against the plate surface 14 to transfer the ink 16 remaining in a cell 22 of the gravure plate cylinder 12, and a transfer characteristics control mechanism 28 configured to control ink transfer characteristics by supplying a gas 26 selected from the group consisting of air having predetermined humidity, dry air, and an inert gas to at least a part of an ink transfer characteristics control area A between an ink scraping-off point P of the doctor blade 18 on the plate surface 14 and a pressing point Q of the impression cylinder 24 on the plate surface 14.

The ink 16 is stored in an ink pan 38. As the base material 20 to be printed, a web-like base material to be printed is suitably used. Also in the illustrated example, an example of a web-like base material to be printed is illustrated.

The transfer characteristics control mechanism 28 includes a casing 40 arranged above the ink transfer characteristics control area A so as to cover the ink transfer characteristics control area A. A lower surface 46 of the casing 40 is positioned so as to face a circumferential surface 42 of the gravure plate cylinder 12. The lower surface 46 of the casing 40 is formed in an arc shape having a curvature along the circumferential surface 42 of the gravure plate cylinder 12, and gas blow-out ports 32 are formed on the lower surface 46.

An inlet port 30 for the gas 26 is formed in the transfer characteristics control mechanism 28, and the gas 26 taken in through the inlet port 30 is sprayed to at least a part of the ink transfer characteristics control area A from the blow-out ports 32. Further, an exhaust port 34 is also formed in the transfer characteristics control mechanism 28, and a gas 36 to be exhausted in a peripheral atmosphere of the ink transfer characteristics control area A is exhausted.

The ink transfer characteristics control area A refers to an area of the plate surface 14 between the ink scraping-off point P of the doctor blade 18 on the plate surface 14 and the pressing point Q of the impression cylinder 24 on the plate surface 14. That is, the gas 26 is supplied to the plate surface 14 between the ink scraping-off point P of the doctor blade 18 on the plate surface 14 and the pressing point Q of the impression cylinder 24 on the plate surface 14 on the circumferential surface across a width direction of the gravure plate cylinder 12.

When the gas 26 selected from the group consisting of air having predetermined humidity, dry air, and an inert gas is supplied to the ink transfer characteristics control area A, the ink transfer characteristics can be controlled. It is preferred that the air having predetermined humidity has a predetermined humidity of 10% RH to 80% RH. As the dry air, air having RH of less than 10% can be suitably used. As the inert gas, there are given, for example, nitrogen gas and argon gas.

In gravure printing, when the ink 16 in the cell 22 during application of a printing pressure by the doctor blade 18 is excessively dried, highlight characteristics are lost. When drying of the ink 16 is delayed, a non-engraved region is contaminated. Thus, the ink transfer characteristics are influenced by the temperature and humidity of a printing atmosphere and the composition of a solvent in the ink.

In view of the foregoing, in order to control and improve the ink transfer characteristics in gravure printing, the gas 26 selected from the group consisting of air having predetermined humidity, dry air, and an inert gas is supplied to the ink transfer characteristics control area A, thereby being capable of controlling the ink transfer characteristics. With this configuration, suppression of so-called plate fogging at a time of printing and an improvement of the ink transfer property in a highlight portion can be performed.

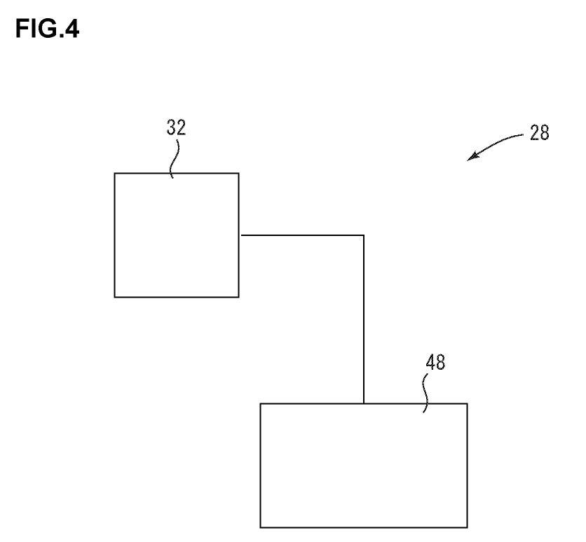

It is preferred that the transfer characteristics control mechanism 28 include a gas supply amount regulating mechanism 48 configured to regulate the supply amount of the gas 26. This is because the supply amount of the gas 26 can be easily regulated. One embodiment of the transfer characteristics control mechanism 28 is illustrated in a block diagram of FIG. 4. The transfer characteristics control mechanism 28 has the blow-out ports 32 for the gas 26 connected to the gas supply amount regulating mechanism 48, and the gas 26 that has been regulated blows out from the blow-out ports 32.

It is further preferred that the gas supply amount regulating mechanism 48 include at least one of a thermometer configured to measure a temperature of an ink transfer characteristics control area atmosphere 44 between the lower surface 46 of the casing 40 and the circumferential surface 42 of the gravure plate cylinder 12, a hygrometer configured to measure a humidity of the ink transfer characteristics control area atmosphere 44, and a temperature sensor configured to measure a plate surface temperature of the gravure plate cylinder, and by performing feedback control, the supply amount of the gas be regulated. This is because the ink transfer characteristics in gravure printing are influenced by the temperature and humidity of a printing atmosphere and the composition of a solvent in the ink. In order to measure a humidity and a temperature of the atmosphere 44 of the ink transfer characteristics control area A between the lower surface 46 of the casing 40 and the circumferential surface 42 of the gravure plate cylinder 12, it is preferred that the ink transfer characteristics control area A between the lower surface 46 of the casing 40 and the circumferential surface 42 of the gravure plate cylinder 12 be as close as possible to a closed system.

As the thermometer configured to measure a temperature of the ink transfer characteristics control area atmosphere 44, the hygrometer configured to measure a humidity of the ink transfer characteristics control area atmosphere 44, and the temperature sensor configured to measure a plate surface temperature of the gravure plate cylinder, known commercially available ones can be employed. Further, also regarding the feedback control, a known commercially available control circuit, for example, control by parameters of PID can be employed. The temperature and humidity of a printing atmosphere and the plate surface temperature of the gravure plate cylinder are measured, and feedback control is performed based on the results, to thereby regulate the supply amount of the gas. Further, a solvent in the ink is liable to volatilize in some cases, and is influenced also by the temperature and humidity of the atmosphere. Therefore, the supply amount of the gas is regulated also in consideration of elements such as the composition of the solvent in the ink. Further, as the gas supply amount regulating mechanism 48, an air-conditioning unit such as a commercially available cooling and heating apparatus can also be used. As the commercially available air-conditioning unit, for example, an air-conditioning system using refrigerant such as chlorofluorocarbon or an air-conditioning system configured to perform cooling through use of a Peltier element may be used.

In the gravure printing apparatus 10, as the configurations of the gravure plate cylinder 12, the impression cylinder 24, and the like, other than the configuration of the transfer characteristics control mechanism 28, configurations known in the related art can be employed.

A gravure printing method of the present invention includes: through use of the gravure printing apparatus 10 configured as described above, after scraping off the superfluous ink 16 on the plate surface 14 of the gravure plate cylinder 12 with the doctor blade 18; supplying the gas 26 selected from the group consisting of air having predetermined humidity, dry air, and an inert gas to at least a part of the plate surface 14 of the ink transfer characteristics control area A between the ink scraping-off point P of the doctor blade 18 on the plate surface 14 and the pressing point Q of the impression cylinder 24 on the plate surface 14; and pressing the base material 20 to be printed against the plate surface 14 with the impression cylinder 24 to transfer the ink 16 remaining in the cell 22 of the gravure plate cylinder 12 onto the base material 20 to be printed.

A printed matter manufacturing method of the present invention includes: through use of the gravure printing apparatus 10 configured as described above, after scraping off the superfluous ink 16 on the plate surface 14 of the gravure plate cylinder 12 with the doctor blade 18; supplying the gas 26 selected from the group consisting of air having predetermined humidity, dry air, and an inert gas to at least a part of the plate surface 14 of the ink transfer characteristics control area A between the ink scraping-off point P of the doctor blade 18 on the plate surface 14 and the pressing point Q of the impression cylinder 24 on the plate surface 14; and pressing the base material 20 to be printed against the plate surface 14 with the impression cylinder 24 to transfer the ink 16 remaining in the cell 22 of the gravure plate cylinder 12 onto the base material 20 to be printed, to thereby manufacture a printed matter.

### REFERENCE SIGNS LIST

10: gravure printing apparatus, 12: gravure plate cylinder, 14: plate surface, 16: ink, 18: doctor blade, 20: base material to be printed, 22: cell, 24: impression cylinder, 26: gas, 28: transfer characteristics control mechanism, 30: inlet port for the gas, 32: gas blow-out port, 34: exhaust port, 36: gas to be exhausted, 38: ink pan, 40: casing, 42: circumferential surface, 44: ink transfer characteristics control area atmosphere, 46: lower surface of casing, 48: gas supply amount regulating mechanism, A: ink transfer characteristics control area, P: ink scraping-off point of doctor blade, Q: pressing point of impression cylinder on plate surface.

1. A gravure printing apparatus, comprising:
a gravure plate cylinder;
a doctor blade configured to scrape off a superfluous ink from a plate surface of the gravure plate cylinder;
an impression cylinder configured to press a base material to be printed against the plate surface to transfer an ink remaining in a cell of the gravure plate cylinder; and
a transfer characteristics control mechanism configured to control ink transfer characteristics by supplying a gas comprising one of air having predetermined humidity, dry air, and an inert gas to at least a part of an ink transfer characteristics control area between an ink scraping-off point of the doctor blade on the plate surface and a pressing point of the impression cylinder on the plate surface.

2. A gravure printing apparatus according to claim 1, wherein:
the transfer characteristics control mechanism includes a casing arranged above the ink transfer characteristics control area so as to cover the ink transfer characteristics control area;
a lower surface of the casing is positioned so as to face a circumferential surface of the gravure plate cylinder;
the lower surface of the casing is formed in an arc shape having a curvature along the circumferential surface of the gravure plate cylinder, and a gas blow-out port is formed on the lower surface.

3. A gravure printing apparatus according to claim 1, wherein a predetermined humidity of the air having predetermined humidity is 10% RH to 80% RH.

4. A gravure printing apparatus according to claim 1, wherein the transfer characteristics control mechanism includes a gas supply amount regulating mechanism configured to regulate a supply amount of the gas.

5. A gravure printing apparatus according to claim 4, wherein:
the gas supply amount regulating mechanism includes at least one of a thermometer configured to measure a temperature of an ink transfer characteristics control area atmosphere that is an atmosphere of the ink transfer characteristics control area between the lower surface of the casing and the circumferential surface of the gravure plate cylinder, a hygrometer configured to measure a humidity of the ink transfer characteristics control area atmosphere, and a temperature sensor configured to measure a plate surface temperature of the gravure plate cylinder; and
the supply amount of the gas is regulated by performing feedback control.

6. A gravure printing method, comprising:
providing a gravure printing apparatus comprising a gravure plate cylinder, a doctor blade configured to scrape off a superfluous ink from a plate surface of the gravure plate cylinder, an impression cylinder configured to press a base material to be printed against the plate surface to transfer an ink remaining in a cell of the gravure plate cylinder and a transfer characteristics control mechanism configured to control ink transfer characteristics by supplying a gas comprising one of air having predetermined humidity, dry air, and an inert gas to at least a part of an ink transfer characteristics control area between an ink scraping-off point of the doctor blade on the plate surface and a pressing point of the impression cylinder on the plate surface;
after scraping off the superfluous ink from the plate surface of the gravure plate cylinder with the doctor blade;
supplying the gas comprising one of the air having predetermined humidity, the dry air, and the inert gas to at least the part of the ink transfer characteristics control area between the ink scraping-off point of the doctor blade on the plate surface and the pressing point of the impression cylinder on the plate surface; and
pressing the base material to be printed against the plate surface with the impression cylinder to transfer an ink remaining in a cell of the gravure plate cylinder onto the base material to be printed.

7. A printed matter manufacturing method, comprising:
providing a gravure printing apparatus comprising a gravure plate cylinder, a doctor blade configured to scrape off a superfluous ink from a plate surface of the gravure plate cylinder, an impression cylinder configured to press a base material to be printed against the plate surface to transfer an ink remaining in a cell of the gravure plate cylinder and a transfer characteristics control mechanism configured to control ink transfer characteristics by supplying a gas comprising one of air having predetermined humidity, dry air, and an inert gas to at least a part of an ink transfer characteristics control area between an ink scraping-off point of the doctor blade on the plate surface and a pressing point of the impression cylinder on the plate surface;
after scraping off the superfluous ink from the plate surface of the gravure plate cylinder with the doctor blade;
supplying the gas comprising one of the air having predetermined humidity, the dry air, and the inert gas to at least the part of the ink transfer characteristics control area between the ink scraping-off point of the doctor blade on the plate surface and the pressing point of the impression cylinder on the plate surface; and
pressing the base material to be printed against the plate surface with the impression cylinder to transfer an ink remaining in a cell of the gravure plate cylinder onto the base material to be printed, to produce a printed matter.

8. A method according to claim 7, wherein:
the transfer characteristics control mechanism includes a casing arranged above the ink transfer characteristics control area so as to cover the ink transfer characteristics control area;
a lower surface of the casing is positioned so as to face a circumferential surface of the gravure plate cylinder;
the lower surface of the casing is formed in an arc shape having a curvature along the circumferential surface of the gravure plate cylinder, and a gas blow-out port is formed on the lower surface.

9. A method according to claim 7, wherein a predetermined humidity of the air having predetermined humidity is 10% RH to 80% RH.

10. A method according to claim 7, wherein the transfer characteristics control mechanism includes a gas supply amount regulating mechanism configured to regulate a supply amount of the gas.

11. A method according to claim 10, wherein:
the gas supply amount regulating mechanism includes at least one of a thermometer configured to measure a temperature of an ink transfer characteristics control area atmosphere that is an atmosphere of the ink transfer characteristics control area between the lower surface of the casing and the circumferential surface of the gravure plate cylinder, a hygrometer configured to measure a humidity of the ink transfer characteristics control area atmosphere, and a temperature sensor configured to measure a plate surface temperature of the gravure plate cylinder; and
the supply amount of the gas is regulated by performing feedback control.

12. A method according to claim 6, wherein:
the transfer characteristics control mechanism includes a casing arranged above the ink transfer characteristics control area so as to cover the ink transfer characteristics control area;
a lower surface of the casing is positioned so as to face a circumferential surface of the gravure plate cylinder;
the lower surface of the casing is formed in an arc shape having a curvature along the circumferential surface of the gravure plate cylinder, and a gas blow-out port is formed on the lower surface.

13. A method according to claim 6, wherein a predetermined humidity of the air having predetermined humidity is 10% RH to 80% RH.

14. A method according to claim 6, wherein the transfer characteristics control mechanism includes a gas supply amount regulating mechanism configured to regulate a supply amount of the gas.

15. A method according to claim 14, wherein:
the gas supply amount regulating mechanism includes at least one of a thermometer configured to measure a temperature of an ink transfer characteristics control area atmosphere that is an atmosphere of the ink transfer characteristics control area between the lower surface of the casing and the circumferential surface of the gravure plate cylinder, a hygrometer configured to measure a humidity of the ink transfer characteristics control area atmosphere, and a temperature sensor configured to measure a plate surface temperature of the gravure plate cylinder; and
the supply amount of the gas is regulated by performing feedback control.

16. A gravure printing apparatus according to claim 2, wherein a predetermined humidity of the air having predetermined humidity is 10% RH to 80% RH.

17. A gravure printing apparatus according to claim 2, wherein the transfer characteristics control mechanism includes a gas supply amount regulating mechanism configured to regulate a supply amount of the gas.

18. A gravure printing apparatus according to claim 3, wherein the transfer characteristics control mechanism includes a gas supply amount regulating mechanism configured to regulate a supply amount of the gas.
